(19) United States
(12) Patent Application Publication
(10) Pub. No.: US 2014/0368476 A1
(43) Pub. Date: Dec. 18, 2014

(54) FURNITURE SYSTEM WITH INTEGRATED DISPLAY AND LOW-VOLTAGE CONNECTIVITY

(71) Applicant: Hit Play Technologies Inc., Toronto (CA)

(72) Inventors: Eric RAUCH, Toronto (CA); Kevin RAUCH, Toronto (CA); Aaron BRADLEY, Toronto (CA)

(21) Appl. No.: 13/918,667

(22) Filed: Jun. 14, 2013

(51) Int. Cl. H02J 1/00

(52) U.S. Cl. CPC H02J 1/00
USPC 345/204; 307/31; 345/30

(57) ABSTRACT

Furniture systems are provided with integrated media presentation devices, such as a display panel, where internal connections between the media presentation devices and internal components for signal and power delivery are provided via low-voltage cables, and where the integrated media devices are connectable to an external computing or media content delivery device. In some embodiments, a mobile media access and control unit is provided that may be removably interfaced with a media presentation device in a low-voltage furniture system for displaying media content and optionally for sourcing power, where the mobile media access and control unit includes a plurality of media inputs for receiving media content from a plurality of computing devices, and a mechanism for selectively delivering media content from one of the computing devices to the media presentation device within the furniture system in response to input from a user.

### CROSS-REFERENCE TO RELATED APPLICATION

This application claims priority to U.S. Provisional Application No. 61/659,712, titled “FURNITURE SYSTEM WITH INTEGRATED DISPLAY AND LOW-VOLTAGE CONNECTIVITY” and filed on Jun. 14, 2012, the entire contents of which is incorporated herein by reference.

### BACKGROUND

The present disclosure is related to furniture, wall systems and other structures with integrated media devices. The present disclosure is also related to collaborative office display systems for displaying video and sharing media content with multiple individuals.

There are a number of trends occurring in workspace design, leading to a transition to a more open concept setting in order to a foster collaborative work environment. These trends are fueled in part by rising real estate costs, which put pressure on businesses to reduce the average square foot office per worker as well as provide enhanced connectivity through adaptable, collaborative workspaces. In addition, workers are vocalizing their desire for more connectivity and flexibility in the workplace without sacrificing privacy. Yet another driver of this trend of collaborative workspace design is the LEED rating system, which is playing a role in influencing workspace environments that aim to conserve energy usage.

### SUMMARY

In some embodiments, furniture systems are provided with integrated media presentation devices, such as a display panel, where internal connections between the media presentation devices and internal components for signal and power delivery are provided via low-voltage cables, and where the integrated media devices are connectable to an external computing or media content delivery device. In some embodiments, a mobile media access and control unit is provided that may be removably interfaced with a media presentation device in a low-voltage furniture system for displaying media content and optionally for sourcing power, where the mobile media access and control unit includes a plurality of media inputs for receiving media content from a plurality of computing devices, and a mechanism for selectively delivering media content from one of the computing devices to the media presentation device within the furniture system in response to input from a user.

Accordingly, in one aspect, there is provided an integrated media presentation furniture system comprising:

a furniture structure configured to support at least one low-voltage media device thereon or therein;

an electrical conduit supported within said furniture structure;

a driver assembly housed within said electrical conduit, wherein said driver assembly comprises:
an input interface configured to:
   receive a source of low-voltage power; and
   receive one or more media signals from an external device; and
a media processor for processing said media signals to produce low-voltage output signals formatted for said low-voltage media device; and
an output interface configured to:
   output said low-voltage output signals; and
   output low-voltage power suitable to power said low-voltage media device; and

connection means for connecting said low-voltage media device to said output interface of said driver assembly.

The integrated media presentation furniture system further may further comprise:

an external connection interface in electrical communication with said driver assembly;

wherein said external connection interface is configured to interface with a portable media device such that media signals are received from the portable media device and provided to said driver assembly for processing therein; and

wherein said external connection interface is further configured to provide low-voltage power from said driver assembly to the portable media device.

In another aspect, there is provided a portable media access and control unit, comprising:

a portable support structure;

a media selection and switching assembly supported by said portable support structure, said media selection and switching assembly comprising:

a plurality of media connection devices, each media connection device comprising:
an external input interface for receiving media signals from an external media device; and
a media selection device associated with said external input interface, wherein said media selection device is configured to be actuated by a user;

a media switching device having a plurality of inputs, wherein each input is in electrical communication with one of said external input interfaces; and

a controller in electrical communication with said media selection devices and said media switching device;

wherein said controller is configured to control said media switching device such that when a user activates a media selection device of a particular media connection device, the media signal provided to the external input interface of the particular media connection device is provided at the output of the media switching device; and

an external connection interface configured to interface with a corresponding external connection interface of an integrated media presentation furniture system as described above.

In another aspect, there is provided an integrated media presentation furniture system comprising:

a furniture structure configured to support at least one low-voltage media device thereon or therein;

an electrical conduit supported within said furniture structure;

a low-voltage power distribution assembly housed within said electrical conduit, wherein said low-voltage power distribution assembly comprises:
an input interface configured to:
   receive a source of low-voltage power; and
   receive at least one low-voltage media signal from an external device; and
an output interface configured to:
   output said low-voltage media signal; and
   output low-voltage power suitable to power said low-voltage media device; and

connection means for connecting said low-voltage media device to said output interface of said low-voltage power distribution assembly.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 illustrates an example implementation of the layout of electronics and cabling within a modular in-panel furniture system. The location of the outlets and cable runs may vary depending on the configuration of the furniture panel and as a result, length and dimensions of armored cable may vary.

FIG. 2 depicts an example implementation of the power management components of a modular in-panel furniture system. This diagram illustrates an example implementation of the technical specifications of the AC/DC module that provides and distributes power to the system safely. The power supply may be a traditional 120 VAC AC/DC module. The module may be configured to fit into a standardized form factor that can be assembled into the systems furniture raceway.

FIG. 3 shows one example embodiment illustrating the various example components of the driver assembly that is housed within the raceway, with the inclusion of a built-in AC/DC convertor. The system provides connectivity to power and distributes the various signals to the display. The configuration will vary depending on the number of displays.

FIG. 4 depicts another example embodiment illustrating various example components of the driver assembly that is housed within the raceway, with the exclusion of the AC/DC convertor (which may be housed externally). The system provides connectivity to power and distributes the various signals to the display. The configuration will vary depending on the number of displays.

FIG. 5 depicts the driver card block diagram for an example configuration of a modular in-panel furniture system. This block diagram outlines the components of the example embodiment along with the signals and/or commands that are distributed from the various components (video and power signal line routing) to ensure that the system functions properly. According to the present example embodiment that is shown, the driver card, power supply and input video ports (housed in the raceway) are separate from the LCD display, touch overlay, LED backlight, speakers, USB and camera mic (housed in the systems furniture panel). The module may be configured to fit into a standardized form factor that can be assembled into the systems furniture raceway.

FIG. 6 depicts an example configuration of an in-panel display including a single display.

FIG. 7 depicts another example configuration of an in-panel display including two displays.

FIG. 8(a) depicts an example configuration of an in-panel display including four display (quad configuration).

FIG. 8(b) depicts an example configuration of an in-panel display with dual displays oriented in portrait mode.

FIG. 9(a) depicts an example configuration of the display attached to a lower middle panel of a furniture frame.

FIG. 9(b) depicts an example configuration of the display attached to the main channel of the furniture frame.

FIG. 9(c) depicts an example configuration of the display attached to a glass partition, as opposed to a furniture panel.

FIG. 10 provides an isometric front view of an example embodiment of the mechanical design of the multimedia bezel, shown without the display. The components serve to flush-mount the display panel within the furniture panel. Also shown is a mounting hinge, which may be employed to adjust the display to meet personal viewing preferences. In some embodiments, the bezel may be modified to not include the custom cutout for the video conferencing camera. The bezel and mounts may be formed from a wide range of suitable materials (such as, but not limited to, plastics, metals such as aluminum steel, and composite materials) depending on the application.

FIG. 11 depicts a cross section of an example embodiment of the display panel, and associated mounting hardware, within the housing. The display bezel may be form fitted to the panel and is clipped in (plastic, metal or aluminum) to secure it to the furniture panel during installation. In some embodiments, the display may be flush mounted and can be moved forward, up or down by utilizing the articulating arm. The default setting may be flush mounted to the furniture panel. The low-voltage differential signaling (LVDS) cable may be run through the articulating arm and into the display to provide both power and display signals and/or commands.

FIG. 12 illustrates an isometric back view of an embodiment of the display bezel and the furniture panel. The furniture panel may be attached to, or support on, the frame of the furniture wall, using a wide variety of attachment means, including for example, clips (for example, utilizing the manufacturer's clips). No change may be needed to this process, relative to conventional panel securing methods, in order to accommodate securing the in-panel display. The bezel/housing may be clipped into the furniture panel by rotating the clips once it has been fitted through. The combination of the clips and the front bezel act as a vice grip to secure it to the furniture panel (as shown in FIG. 14, Detail A).

FIG. 13 provides a detailed view of an example of a clamping mechanism, which is employed to secure the bezel/housing to the furniture panel. The clamping mechanism may be formed, for example, from steel, plastic, aluminum, or other suitable materials, depending on the application and parts.

FIG. 14 illustrates an embodiment of a portable in-table collaboration system, which may be interfaced with individual workstations, the Figure depicting the connectors in the mobile portable media access and control unit and the mating connectors for a number of associated workspaces, to which the mobile portable media access and control unit may be connected for portable and reconfigurable use in a collaborative meeting environment.

FIG. 15 illustrates the connection of the portable in-table collaboration system with an associated workstation. The in-table system is mated with the connectors and interface that is housed underneath the workstation. Power is sourced from underneath the workstation and signals are sent to the display via HDMI connectors from the users. Users seated at the in-table collaboration system pull out the HDMI connectors and plug them into a suitable computing device, which enables content from their device to be viewed on the workstation display by actuating the capacitive touch mechanism on the HDMI connector.

FIGS. 16(a) and (b) provide an illustration of an example in-table collaboration system, showing (a) top and (b) side views. In some embodiments, the system may be housed on or within a mobile or fixed conference table of varying dimensions and materials (e.g. laminate, wood, steel, plastic). According to some embodiments, a cutout is made to provide access to the connectors and the unit is affixed (e.g. via screws) to the base or underside portion of the table top. The table may be placed on wheels to enable a mobile meeting space.

FIGS. 17 (a) and (b) is a block diagram illustrating an example embodiment of signal distribution within a media access and control system. The block diagrams outline the components example system, along with the signals that are distributed from the various components (video, switching, processing and power signals). The present non-limiting example shown includes four video inputs. All switching signals are defined as shown in FIG. 3. The interface connector provides the power and video signal commands to mate between a display unit and the collaboration system.

FIG. 18 depicts an embodiment of a cord retraction mechanism for data, video or other media cables (e.g. HDMI or VGA). Video cables may be pulled by the user, and the pulley mechanism is activated to manage tension and locked in the proper cable distance required by the user. This prevents retraction without user intervention. To retract, the user tugs at the cable slightly and the cable retracts back into the mechanism.

FIGS. 19(a) and (b) depict an embodiment of an HDMI connector with a built in switch, showing (a) top and (b) rear views. This connector is plugged into a computing device such as a laptop, PDA, mobile or tablet device for providing display signals. The HDMI connector sends the signal (on/off touch) to the display that the user would like to display his/her content on the display. When the user hits the capacitive touch mechanism the switch lights up to indicate that it is on. When the user hits it again, the light goes off to indicate that it is off.

FIGS. 20(a)-(d) illustrate various example implementations of a cable/connector interface for connecting a portable media access and control unit to a systems furniture unit or workstation.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure. It should be understood that the order of the steps of the methods disclosed herein is immaterial so long as the methods remain operable. Moreover, two or more steps may be conducted simultaneously or in a different order than recited herein unless otherwise specified.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

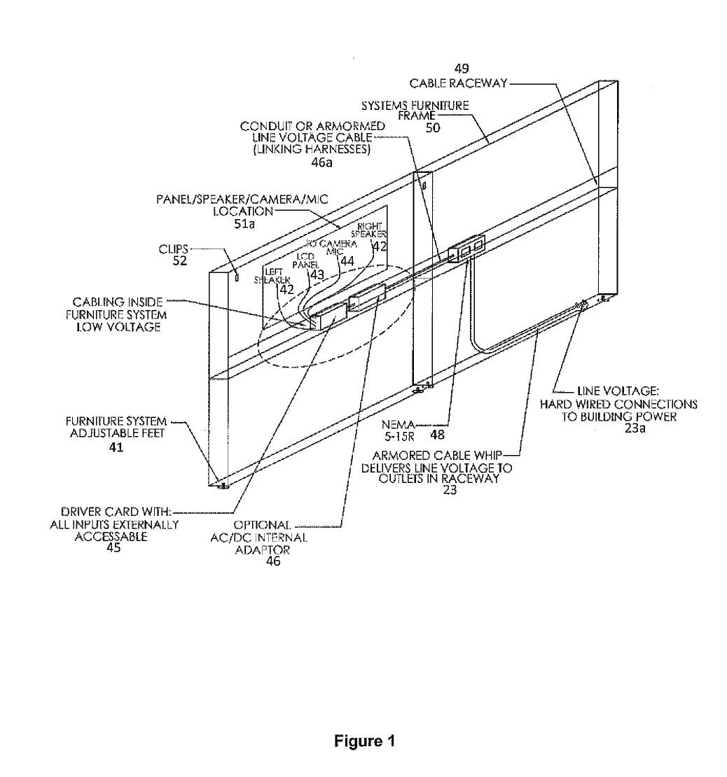

Referring now to FIG. 1, an illustration is provided of an example embodiment of a modular, in-panel, furniture system that is configured for the integration of a display into a vertical panel of modular furniture assembly. FIG. 1 shows an isometric view of the in-panel furniture system, in which a modular vertical panel frame 50 is shown supporting one or more vertical panels.

The furniture panels may be comprised of, but are not limited to, materials such as polyester, leather, veneer, plastics, aluminum, steel, laminate and wood. The frames of currently available panels are typically comprised of steel and plastic.

The raceway 49 is channeled through furniture system frame (typically the same width as the furniture frame however in newer systems furniture models it is structured like a well and can be wider). It may be employed for the routing and protection of high performance copper, voice, video, fibre-optic and electrical wiring for the office. It is typically made of aluminum or steel to support the electrical equipment, and may contain holes to channel necessary cabling through to power sources. Discrete, adjustable covers may be employed to hide cabling and access connectivity on demand by the user.

As shown in the Figure, the example modular system is configured to support one or more low-voltage media presentation or recording devices (which may be supported, for example, by the frame and/or panel) for presenting media to one or more users, or for recording media from one or more users. For example, a display 25 (not shown) may be supported at the location generally shown at 51a. As described below, the display and/or other media devices may be provided within a removable panel 51 for inclusion in a modular panel system. Methods and mechanisms for the display 25 are discussed in further detail below.

The media devices are in electrical communication, via cables or other suitable transmission means (including wireless transmission devices), to the driver assembly 45 (which may contain a driver card), which is configured to provide low-voltage power to the media devices, and to transmit and/or receive low-voltage signals to and/or from the media devices. By decoupling/deconstructing the display assembly, the power adaptor may be relocated to the systems furniture raceway or a suitable electrical conduit, thereby enabling a media device such as a display (e.g. a low-voltage driven OLED/LED/LCD display) to be powered by low voltage DC power. This reduces electrical fire and electrocution risks by limiting conductivity, addresses compliance requirements of section 400.8 of the National Electrical Code, and may address compliance/claim requirements of insurance policies. The driver assembly 45 and optional AC/DC power supply 46 may be configured to snap into system's furniture bus bar based on a particular manufacturer's standard, thus securing the driver assembly and optional power supply in place along with the furniture raceway or electrical conduit.

It is to be understood that the term “low-voltage” may depend on the application and/or the electrical properties of the media device(s). In some embodiments, low-voltage may be a voltage that lies between approximately 1V-24V. Example and non-limiting low-voltage values according to the components described further below include: Media Processing Unit—1-5 Volt range; HDMI Switch—12V; LVDS Interface—1V-3.3V; AC/DC Power Adaptor Output: less than 24V.

In various embodiments disclosed herein, any or all components of the system located within the systems furniture unit (for example, including a display) are powered via DC voltage. DC power is distributed from within driver assembly 45, thereby improving safety considerations and enabling the various components to be housed within the furniture panel according to 400.8 of NEC. Many of the embodiments disclosed herein involve the furniture systems that are configured for the integration of a low-voltage display. In such embodiments, the display may be any suitable display that is configured for low-voltage signals and power delivery. One class of display devices is thin film transistor liquid crystal displays (TFT-LCD) with backlight, which may include Twisted nematic (TN), In-Plane Switching (IPS), Advanced fringe field switching (AFFS), Multi-domain vertical alignment (MVA), Patterned vertical alignment (PVA), Advanced super view (ASV), and/or Plane Line Switching (PLS). Example backlight technologies include incandescent light bulbs, and light-emitting diodes, (LEDs), electroluminescent panel (ELP) displays, Cold Cathode Fluorescent Lamps (CCFL), Hot Cathode Fluorescent Lamps (HCFL), External Electrode Fluorescent Lamps (EEFL). Another class of suitable displays includes Active-Matrix Organic Light-Emitting Diode (AMOLED), such as Emissive Electroluminescence OLED, Super AMOLED, Advanced Super AMOLED, and Plus HD Super AMOLED. Other suitable display technologies include flexible OLEDs, flexible LCDs, and transparent OLEDs. Any one or more of these displays may be incorporated into a furniture panel or other furniture device according to various embodiments disclosed herein. In some embodiments, in which the display is sufficiently thin, the bezel and monitor arm (described below) may be omitted.

The example system shown in FIG. 1 includes three cables for low-voltage transmission to media devices: camera & microphone cable 44, display panel cable 43 and audio cables 42. These cables may be combined into one cable and provided to a single connector to the bezel (described below). As shown in embodiments described further below, video and audio signals are distributed from the driver assembly 45 directly to these endpoints.

As further described below, the system may include the following components housed in a modular, low-voltage arrangement: a low-voltage driven display (e.g. an LCD display with a backlight) with the option to add a touch overlay (touch technology includes, but is not limited to IR, camera, capacitive, resistive or other future technology), a video driver card & audio amplifier, and an AC/DC power adaptor. The system may also include additional media devices such as speakers, and a SB camera & microphone.

The modular construction enables the assembly to be housed in a furniture system (or other suitable structure) while meeting NEC/CEC codes, as only low voltage signals will be routed from the raceway to the components housed in the systems furniture panel. Additionally, all input ports can be mounted in a systems furniture raceway for easy access to video and audio connectivity.

External power is provided to the system via an armored cable whip or conduit 23, which is connected to line/wall voltage connector 48 (e.g. a NEMA 5-15R connector). Line voltage connector 48 is located in the raceway area 49, and provides power to power and optional AC/DC adaptor 46, which in turn powers the driver assembly 45. External power cable 23 may extend through frame 50 and emerge through a bottom portion of frame 50 to connect to an external electrical plug 23a provided in the floor, or in a nearby wall. Frame 50 may include adjustable feet 41, which can be adjusted to run necessary cabling through the floor. It is noted that all components and cabling may be discretely housed within the systems furniture paneling and frames and out of sight when not in use. The location of the outlets and cable runs may vary depending on the size and configuration of frame 50 and associated panels, and/or as a result the dimensions and furniture configuration.

Although many of the embodiments disclosed herein include a line voltage connector housed in the raceway, for providing an external line voltage power connection to the user, it is to be understood that other embodiments may be provided or configured without such an intermediate line voltage connector, such that the line voltage whip (armored cable) connects or interfaces directly with an AC/DC converter device housed within the raceway. In other embodiments, all of the electrical wiring within the furniture system may be configured to support low-voltage connectivity, such that the conversion from AC line voltage is performed externally.

The system may be configured to connect and power the display with low voltage DC line power and one ‘plug and play’ (one video/data cable) for easy connectivity, set-up, maintenance and replacement. The display and display panel may be able to be removed for easy repair and/or replacement. The driver assembly 45, power adaptor 46, and cabling are housed within raceway 49 for easy access, maintenance and replacement.

The system may house the display panel so that it is flush with or minimal variance to the exterior dimensions of the systems furniture panel for minimalist aesthetics. This also saves valuable workstation space, the employee office footprint and therefore real estate space.

To provide video conferencing capability, video conferencing codecs may be embedded via custom housing or the codec may be placed on top of the systems furniture panel, with cabling housed and hidden within the paneling.

As shown in FIG. 1, as described further below with reference to FIG. 3, both power adapter 46 and driver assembly 45 may be housed within raceway area 49 (or in a suitable electrical conduit). Although power unit 46 and driver assembly 45 are shown as separate units, they may be provided in a single housing. Suitable hardware may be included to secure driver assembly 45 and power adapter 46, and connector 23 in place along with the furniture raceway.

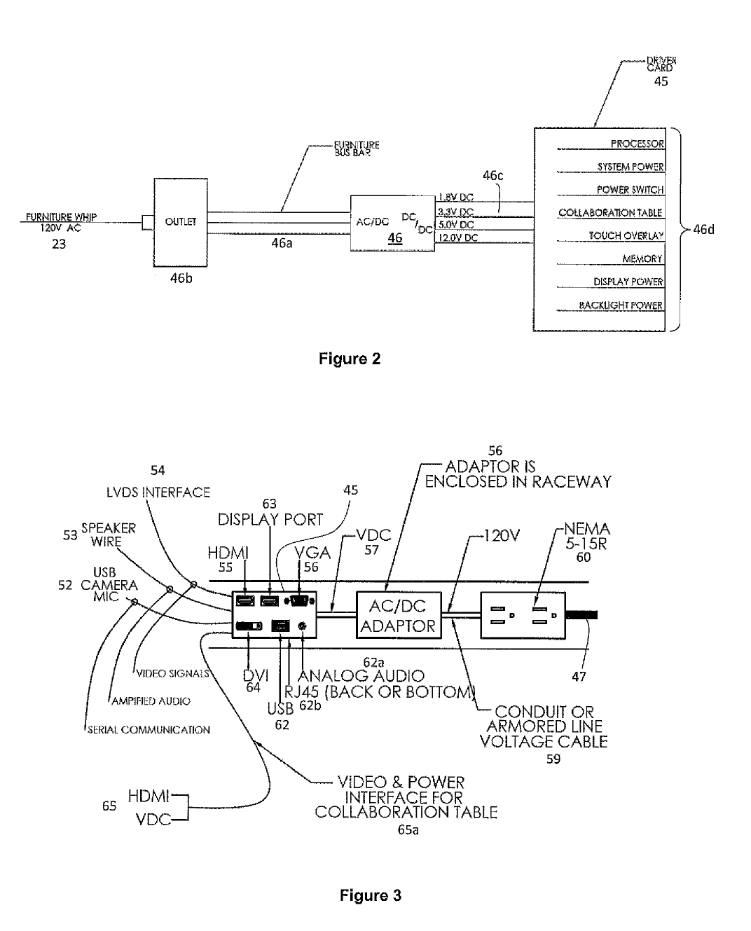

FIG. 2 schematically illustrates how an example AC/DC module 46 may be employed to provide low-voltage DC power to the various components of the system. This AC/DC module 46 is housed within the systems furniture raceway as depicted by FIG. 1. The line voltage connection may be hardwired to the AC/DC module at outlet 46b. The cabling 46a between the raceway power and the AC/DC module may be run in conduit or via armored whip cable to meet National Electrical Code standards. The VDC output of the AC/DC adaptor can be connected with low voltage cabling to the driver assembly. A DC/DC module(s) may be implemented to provide multiple DC outputs 46c to the driver card to support various component voltages. The various DC outputs can be employed to provide power to multiple devices within, and beyond, driver assembly 46.

In one embodiment, an external AC/DC adaptor can be plugged into a standard NEMA 5-15R receptacle that is housed in the raceway. The output of the external power adaptor may then be plugged into a DC input connector on the front face of the driver assembly. DC/DC power conversion and distribution takes place inside the driver card.

FIG. 3 shows the various components that are housed within cable raceway area 49 according to an example implementation with an integrated AC/DC convertor 58. The system provides connectivity for the distribution of power and signals/commands to the low-voltage media devices housed within the system (such as a display). The configuration will vary depending on the type and number of media devices within the housing. In the example embodiment shown, cables for the USB camera & microphone 52, speaker wires 53 and associated with LVDS interface 54 (described further below) run directly from the driver assembly to the various output devices (e.g. LCD Display—LVDS, camera—USB, Speakers—speaker wire). As noted above, a single connection interface may be provided between then the driver assembly and the panel bezel to distribute all signals within the furniture panel.

Users connect an external media or computing device via input connectors of driver assembly 45, such as HDMI connector 55, DVI connector 64, VGA connector 56, USB 62, analog audio connector 62a and/or an RJ45 connector 62b, directly into driver assembly 45. A low voltage connection 57 exists between driver assembly 45 and AC/DC Adaptor 58. The AC/DC Adaptor 58 and NEMA 5-15R 60 are connected via conduit or armored cable 59. The furniture whip is connectable to a building electrical system to provide power to the systems furniture unit. This power is delivered to the raceway via the whip 47 and then on to the AC/DC converter.

In one embodiment, described further below, an additional cable and connector interface may be routed from driver assembly 45 to another location within the furniture system (e.g. under the desk associated with the system forming a workstation environment). This cable harness 65a may contain a video cable (such as an HDMI cable) and DC power to mate with the portable media access and control unit. The connector 65 may be assembled underneath a workstation desk so that it is readily available for connection to a mobile portable media access and control unit (described further below).

It is to be understood that the connectors may vary in type, size and shape, and may include pull out or retractable cables in place of the connectors located on the external face of the driver assembly.

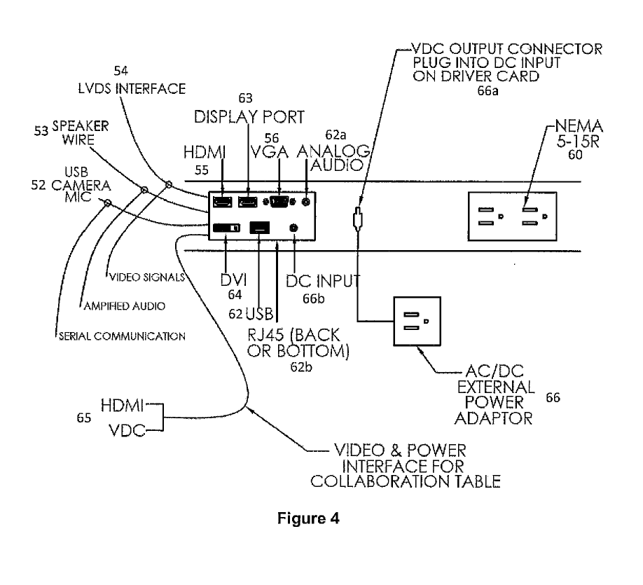

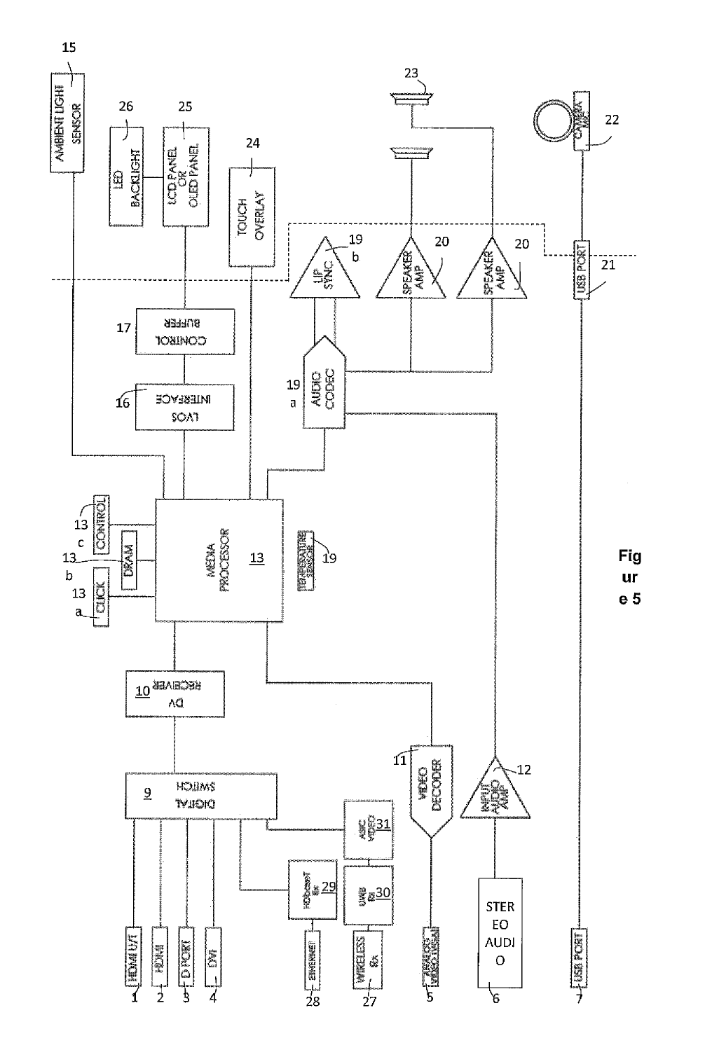

Referring now to FIG. 4, an alternative embodiment is shown, which is similar to FIG. 3, with the exception that the AC/DC adaptor 46 has been removed from the raceway and is now an external adaptor, which plugs directly into NEMA 5-15R receptacle. A low voltage plug 66a is added to the AC/DC adaptor 66 which plugs into a mating connector 66b on the front of the driver card.

FIG. 4 depicts the various components of the driver assembly that are housed within the raceway with the exclusion of the AC/DC convertor (which is housed externally). The configuration may vary depending on the number of displays within the housing. The external AC/DC converter receives power via the NEMA 5-515R connector, to which power is supplied via an armored cable connected through the raceway and paneling housing down and into an outlet on the floor.

Referring now to FIG. 5, a block diagram is provided of an example driver assembly according to one embodiment of a modular in-panel furniture system. This block diagram outlines the components of the example system, along with the signals that are distributed from the various components (e.g. audio, video, data and power routing). It is to be understood that alternative configurations of the driver card components may be employed, and that the components need not be provided on a single driver card.

The driver assembly (e.g. housing a driver card having a layout according to FIG. 5) may incorporate several components that would otherwise reside in a fully functional media device. This allows the integration of simple media devices that do not require substantial on-device processing or power conversion. For example, the driver assembly 45 shown in FIG. 5 is configured to include the following components that would otherwise reside within a conventional LCD Monitor or HDTV: the video driver card & audio amplifier, AC/DC power adaptor, TFT LCD Display & Backlight control for controlling the panel pixels (pixel mapping) 25 and backlight 26. The driver assembly may be configured for graphics processing. The driver assembly may also provide low-voltage connectivity to additional media devices or device components, such as a touch overlay 24, speakers 23, ambient light sensor 15, and a USB camera & microphone 22.

The modular construction enables the driver assembly to be housed in a furniture system while meeting NEC/CEC codes, as only low voltage signals are routed from the raceway to the low-voltage media components housed in the systems furniture panel. Additionally, any or all input ports can be mounted in a systems furniture raceway for easy access to video and audio connectivity. The external media devices are shown above the dashed line. In some embodiments, the driver assembly may be configured such that users may open a compartment to access and connect with the cables/connectors.

It is also to be understood that the components shown are provided merely as an example implementation, and that some components may be optionally removed, and/or additional components may be optionally included, without departing from the scope of the present disclosure.

In the example embodiment shown in FIG. 5, driver ports 1-7 may be provided as right angle connectors located on the edge of the driver card PCB, such that the connector faces are accessible on the external face of the driver card housing. The driver assembly may then be located in the raceway of the systems furniture unit with the connectors facing outwards (as shown in FIG. 3).

When the modular in-panel furniture system is employed as a component of a workstation, a user of the workstation can then connect their computing device (e.g. laptop, tablet, PC, smartphone) into one of the video connectors via a suitable cable (HDMI, Display Port, DVI, VGA, Audio). Both analog and digital video ports may be provided to accommodate legacy and current devices.

In addition to conventional video input connectors, the driver assembly may also be configured to include connectors and components to support video over Ethernet. Video over Ethernet can be enabled through several emerging standards such as Valen's HDBaseT chipset for uncompressed video and Teradici's PCoIP for compressed video. The Ethernet port could be located on the case of the driver assembly and could connect to a CAT cable run to a transmitter or Ethernet switch. The video over Ethernet enables the display to be broadcast to from a central location, enabling the displays throughout the office to be used for digital signage, broadcasts or emergency notifications. The driver assembly may include a wireless digital video receiver or transceiver to facilitate transmission and reception of video signals from a device that supports video over wireless standards such as Apple Airplay, Intel WiDi or other such standards. Wireless video eliminates the need for connecting a cable to share video. As noted above, one or more of the connectors may be located in a position suitable for connection underneath a desk.

One or more USB ports 7, or other suitable connection port(s), may optionally be provided as in a pass-through configuration to connect the user's computing device to an optionally integrated camera and microphone (which are provided as components of the in-panel furniture system). Such an embodiment may be employed to facilitate video and/or audio conferencing or communications, video and/or audio input, and/or other future uses. An additional input to the driver card may be provided for an audio and video link to a mobile portable media access and control unit, as further described below.

The example port configurations shown in FIG. 5 are described below. It is to be understood that these port configurations are provided as illustrative examples, and are not intended to limit the scope of the present disclosure. The numbers shown in the list below refer to the labels shown in FIG. 5.

### Example Digital Video Ports Shown in FIG. 5:

HDMI U/T (1): High Definition Multimedia Interface
HDMI (2): High Definition Multimedia Interface
DP (3): DisplayPort is a digital display interface used to connect a video source to a display device such as a computer monitor, though it can also be used to transmit audio, USB, and other forms of data.
DVI (4): A video display interface developed by the Digital Display Working Group (DDWG). The digital interface is used to connect a video source to a display device, such as a computer monitor. The interface is designed to transmit uncompressed digital video and can be configured to support multiple modes such as DVI-D (digital only), DVI-A (analog only), or DVI-I (digital and analog).
Ethernet Port, RJ45 (28): the video signal has been sent over CAT cable from a transmitter. A receiver chip is implemented using a coding scheme based on Pulse Amplitude Modulation (PAM). The signal is decoded and converted back to a digital video signal (HDMI) and routed to the media processor. Commercially available technology from Valens, HDbaseT, provides the technical foundation for this solution. Competing solutions from Teradici also sent digital video over Ethernet however their technology uses a highly efficient compression scheme.
Wireless Video, No Connector (27): the video signal is encoded and then wirelesses transmitted. The wireless receiver is connected to a decoder and the output is a digital video signal that is routed to the digital video switch.

### Example Analog Video Ports Shown in FIG. 5:

VGA (5): A Video Graphics Array (VGA) connector is a three-row 15-pin DE-15 connector. The 15-pin VGA connector is found on many video cards, computer monitors, and some high definition television sets. On laptop computers or other small devices, a mini-VGA port is sometimes used in place of the full-sized VGA connector.

### Example Analog Audio Ports Shown in FIG. 5:

Stereo Port (6): using the five pins for the four signal connections plus ground to transmit analog audio signals to the speakers.

### Example USB Ports Shown in FIG. 5:

Universal Serial Bus (USB) (7): defines the cables, connectors and communications protocols used in a bus for connection, communication and power supply between computers and electronic devices. It provides signal transmission for the USB port and video conferencing camera mic.

It is to be understood the system may include of any combination of suitable display ports (e.g. VGA and HDMI; video and/or data), cabling, video conferencing cabling, speaker assembly, and embedded within the systems furniture paneling/raceway for increased connectivity. Additional capability may be provided through Ethernet cabling (not shown) to network displays and duplicate PC desktops, mobile, tablet devices, and/or through wireless communications, such as Wi-Fi, wireless Ethernet, and Zigbee.

As shown in FIG. 5 and described above, one or more digital media connectors 1-4 (or other inputs, such as wired Ethernet or wireless) may be included for providing digital media signals to media processor 13. In the example embodiment shown, example digital media connectors include first and second HDMI connectors 1 and 2, display port 3, and DVI connector 4. When two or more digital media connectors are present (as shown in FIG. 5), the connectors for the digital inputs may be routed to an auto-sensing digital video input switch 9.

The active port (as determined by input switch 9) is routed to the output of the input switch 9. The signal is then transmitted to the input of digital video (DV) receiver 10. In one example implementation, digital video receiver 10 may be an adjustable 1.1-V to 1.8-V digital interface providing a low-EMI, high-speed bus that connects seamlessly with 12-bit or 24-bit interfaces.

In one example implementation, digital video receiver 10 supports flat panel display resolutions up to UXGA, for example, at 165 MHz, which may be provided in 24-bit true color pixel format. Such a format is presently a commercially available component from manufacturers such as Texas Instruments. The output of digital video receiver 10 is routed to a video controller input on the media processor 13.

Video decoder 11 is optionally provided to convert analog video signals, such as NTSC, PAL, and SECAM video signals, into a suitable digital format, such as the 8-bit ITU-R BT.656 format. The output of video decoder 11 is routed to the analog input of media processor 13.

Example media processor 13 is a system-on-chip that is programmed to process incoming media signals. Media processor 13 manages the digital streaming of media data in real-time, converting the video signal using color mapping and image scaling to the native resolution of the display panel. The bit stream output from media processor 13 is sent to low-voltage interface 16. In one example, media processor 13 may contain, but is not limited to, a processor, memory, memory controller, stream controller, video signal processing in 2D and/or 3D, audio and video inputs and outputs, audio and video encoding, decoding, and copyright protection support (HDCP). Suitable media processors are commercially available through manufacturers like Panasonic, Intel, Via Systems and others. Although media processor 13 is shown as a single device, it may be provided as two or more distinct devices that are suitably interfaced. One or more additional inputs (not shown) may be provided for interfacing a computing system to media processor 13 in order to provide an interface for optional firmware upgrades.

Clock 13a may be a high performance, ultra low-jitter, multi-rate clock generator capable of synthesizing different frequencies on multiple outputs. Each output clock may be programmable in LVDS, LVPECL or LVCMOS format. Clocking connections may include but are not limited to the processor, audio codec, digital video, memory and display interface.

High-bandwidth DRAM 13b (Dynamic random-access memory) provides the media processor with the required data throughput to accelerate multiple data types simultaneously. In the embodiment shown, all processing elements have access to DRAM memory through a memory controller that is specifically designed to manage the differing bandwidth and latency requirements of media and applications processing. The media processor typically requires a significant amount of high-speed external memory for on screen display (OSD) buffers, buffering for intermediate data while performing video decode functions and storage of executable code for the DSP.

Control 13c functionality is provisioned for in the media processor using, but not limited to, methods such as Infrared Data Access (IrDA), Low Power Radio Frequency (RF) and RS-232 communication protocol. The present example embodiment does not require external controllers. The monitor may be configured to always be on, and to go into standby mode when no input is detected. The driver card input switch auto detects an active input port and routes it to the output of the switch. Display control parameters, such as picture, color, size and position, may be managed through the OSD.

Low-voltage interface 16 may be any suitable processing interface for transmitting high-speed, low-voltage, video signals to a video display device 25 operable at low voltages. Examples of suitable low-voltage interfaces include LVDS (Low-voltage differential signaling), FPD-link (Flat Panel Display Link—uses LVDS), and FlatLink (uses LVDS). For example, LVDS transmits information as the difference between the voltages on a pair of wires; the two wire voltages are compared at the receiver. The LVDS signaling protocol transmits RGB in a number of serial transmission lines synchronized to a clock whose rate is equal to the pixel rate. Other examples of suitable low-voltage interfaces include Embedded DisplayPort and Internal DisplayPort, which are currently the preferred future solutions of Intel and AMD.

The control buffer 17 performs gamma correction. This is a nonlinear operation used to encode and decode luminance or tristimulus values in video or still image systems. Gamma encoding is performed to ensure that there is proper allocation bits/bandwidth to image information such as shadow values that humans are sensitive to maintain visual quality. The temperature sensor 19 is a digital-output temperature sensor. The output can be used to monitor the temperature of the media processor and trigger a fan or other cooling solution to activate. The requirements for active cooling technology would be implemented if required.

Automatic backlight and/or brightness control may be implemented as a software application to work with the media processor's dynamic LVDS backlight driver. Manufacturers such as Intel, implement LVDS display backlight brightness control by applying pulse width modulation (PWM) with power to the backlight. PWM switches the power to the backlight 26 on and off very quickly. To dim the LVDS backlight, the duty cycle of the PWM is decreased accordingly. Toggling the power to the backlight to control its intensity is the de-facto method to control LVDS backlight intensity.

Accordingly, the media processor software controls the backlight intensity by continuously updating the internal LVDS display register, a configurable parameter in the media processor LVDS driver. The software application poles the ambient light sensor 15 and then computes a backlight intensity value based on a defined formula. This process is a continuous feedback loop, dynamically adjusting display brightness depending on ambient light present at the display.

In one embodiment, touchscreen functionality may be included for receiving touch input from a user. For example, as shown in FIG. 5, the system may include a touchscreen controller (not shown), which is in communication with a touch overlay 24 associated with display 25. This feature enables users to reduce the requirement for a keyboard or mouse and manage display content by directly interfacing with the touch overlay and therefore the display.

Analog audio signals 6, which may be optionally amplified by input audio amplifier 12, are routed to the audio codec 19a. Similarly, digital audio signals are decoded from their respective AV connector input, processed and routed by media processor 13 to the audio codec 19a. The stereo analog output of audio codec 19a is routed to a two channel amplifier 20 (e.g. a class D amplifier). The amplified audio signal is sent to left and right speakers 23 mounted in the furniture panel (e.g. in the bezel, as described further below) for conversion from electrical signals to sound pressure via a speaker.

A USB pass through connector 21 (or other suitable pass-through connector) is optionally provided to connect a camera 22, and/or an integrated microphone mounted in the bezel to a user's computing device to facilitate recording audio or video, for video conferencing.

Accordingly, it is apparent from FIG. 5 that the driver assembly is adapted to provide low-voltage electrical signal and power delivery to all panel-mounted devices.

It is to be understood that FIGS. 1-5 represent example implementations of various embodiments of the present disclosure, and that the example implementations may be modified without departing from the intended scope of the present disclosure. For example, in an alternative embodiment, one or more media devices housed within a furniture system or unit may include on-board media processing (such as an on-board video or sound card) that is powered at a low voltage. In such an embodiment, the furniture unit or system need not include media processing capability, and may provide low-voltage power distribution to the various low-voltage media devices without media processing.

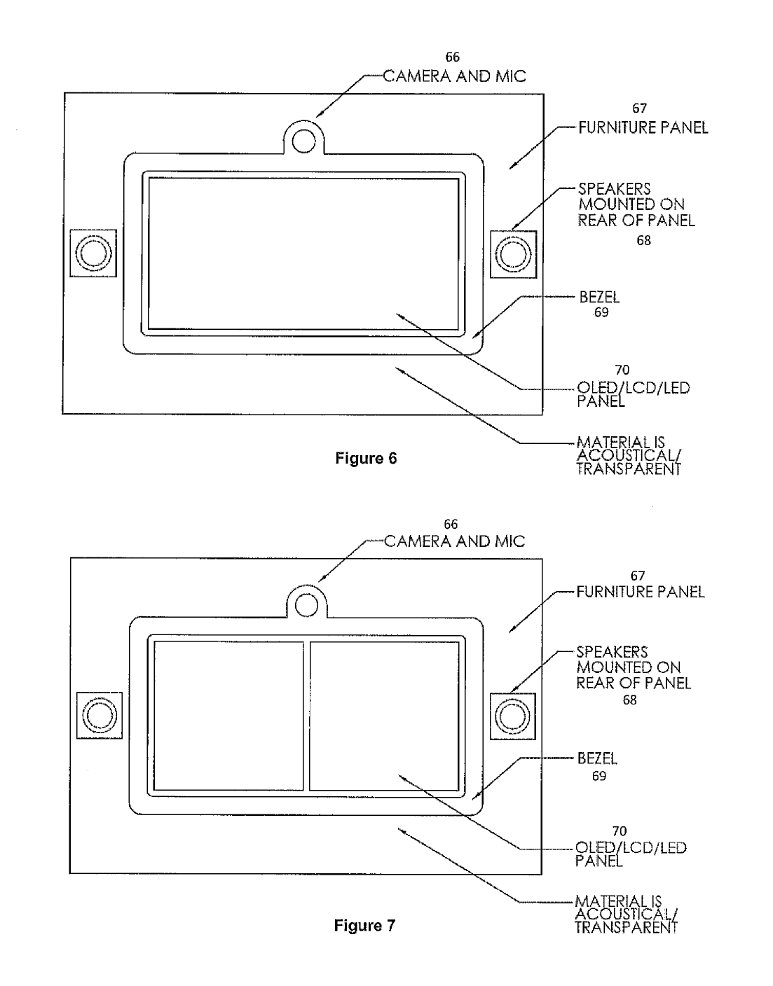

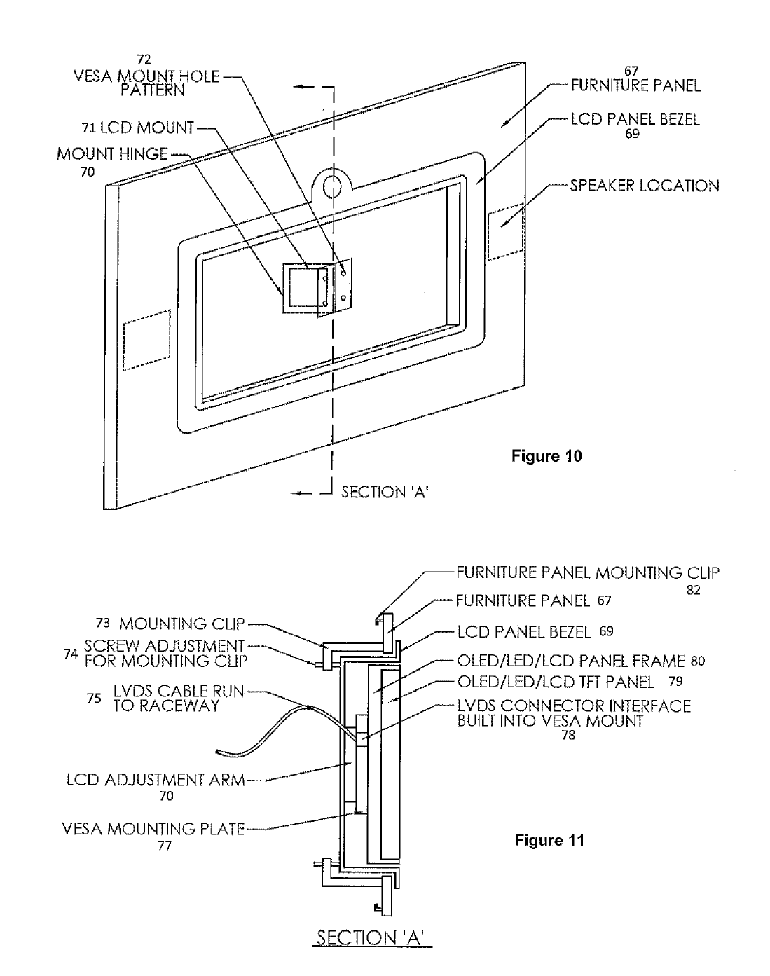

FIGS. 6-8(b) illustrate several example configurations for embedding one or more low-voltage displays within a furniture system panel. In the embodiments shown, the display is supported in part by a housing (bezel). The housing (bezel) holds the display in the furniture panel and optionally provides a mechanism to adjust the viewing angle in all axes (as further shown in FIG. 10). All of the example embodiments shown involve the housing of one or more displays in a single bezel.

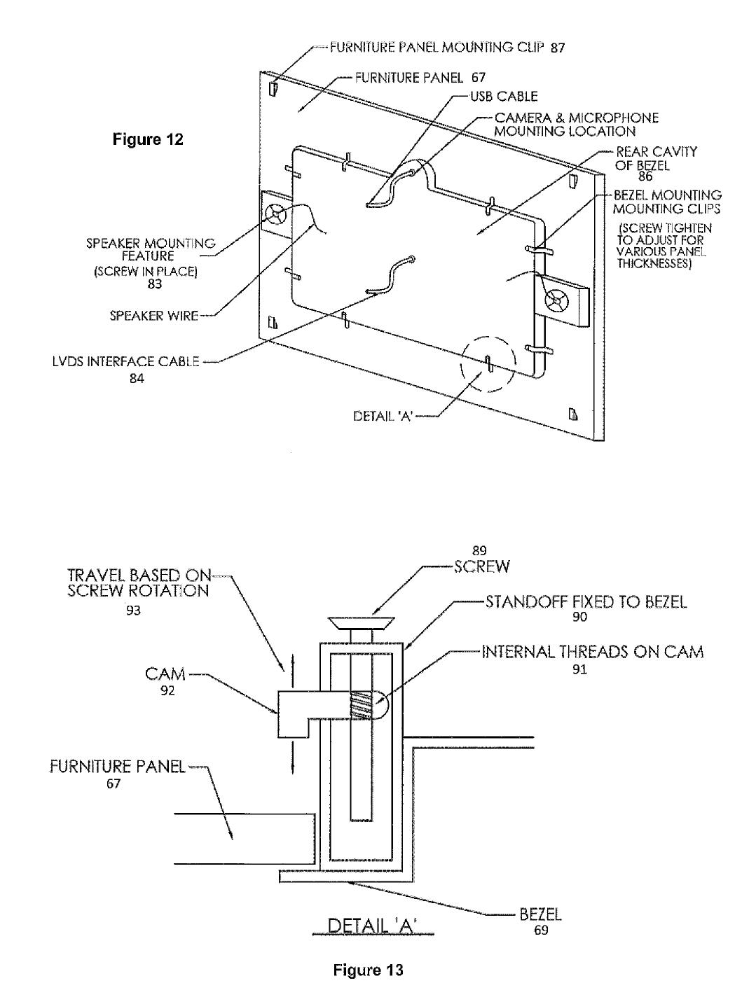

FIG. 6 illustrates an example configuration for mounting a single display 70 within the systems furniture removable panel 67. As shown in the Figure, a cutout and accompanying housing is customized for the display panel (dimensions vary by panel size), video conferencing codec/camera, and audio speakers. Display panel 70 may be mounted to the bezel 69 on an articulating arm (shown in FIG. 12). The articulating arm provides freedom of motion in 3-axis to allow the user to adjust the display height and depth to account for ergonomics. Any suitable (e.g. approved) articulating arm may be utilized and all cabling may be run through the arm to the display. Speaker mounting locations 68 can be to the left, right, top or bottom depending on the monitor configuration. Custom cutouts in the furniture panel may be employed to accommodate the bezel based on the specific configuration. The housing (bezel) may also contain mounting points for a video camera (e.g. a webcam, e.g. USB or other format). The assembly may be flush with the exterior of the furniture panel, thereby occupying little or no desktop real estate.

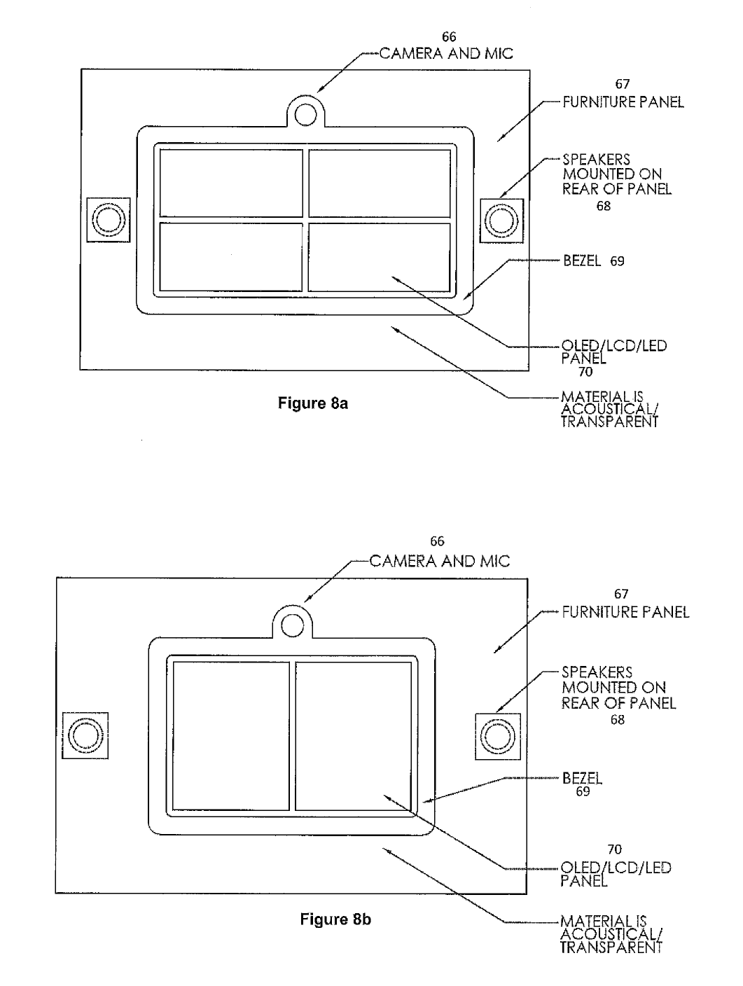

In other example embodiments, shown in FIGS. 7-8(b), a plurality of display panels 70 may be arranged adjacent or above/below to one another in a row or other configuration (e.g. any matrix combination, portrait or landscape), for added functionality (e.g. dual screen video conferencing, collaboration, promotional video, data and presentation at trade shows). A plurality of displays may be mounted within a single bezel 70.

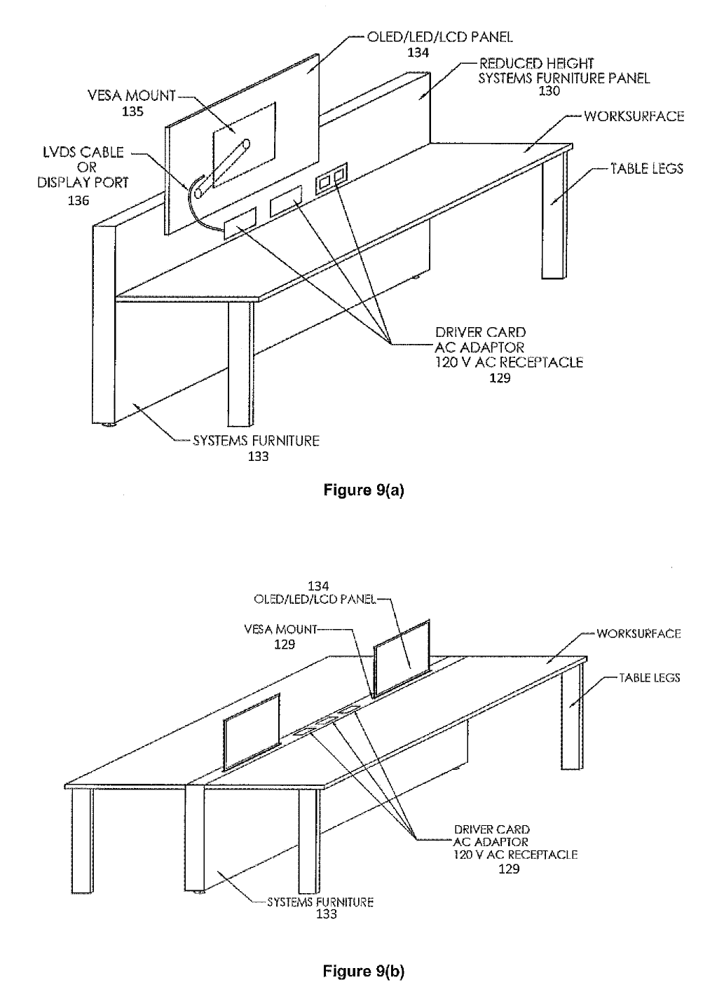

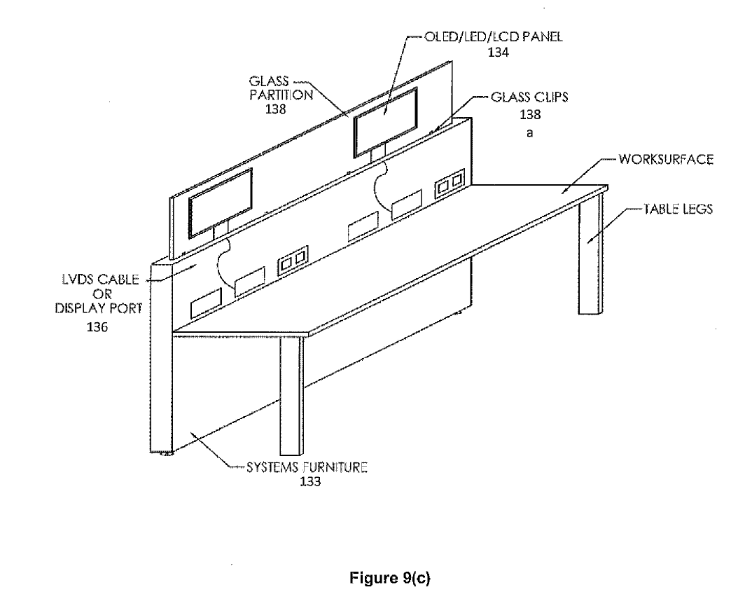

Other example embodiments, shown in FIGS. 9(a), 9(b) and 9(c), address the shift towards a more open concept desk space. FIG. 9(a) depicts an example implementation in which display 134 is integrated into a reduced-height workstation system, which includes tabletop 131, legs 132, and reduced-height panel 130. Display 134, housed in a bezel on an articulating arm/mount 135, is connected to reduced-height panel 130, such that only a portion of the display 134 is embedded within, or mounted in front of, reduced-height panel 130.

FIG. 9(b) depicts an embodiment in which display panel 134 is mounted directly to the systems furniture 133 in the top portion of the middle panel. FIG. 9(c) depicts another alternative embodiment in which display panel 137 is affixed (e.g. laminated) to the surface 138. As shown in the Figure, surface 138 may be a glass partition. Glass clips 138a may be employed to support glass partition 138.

It is to be understood that in the embodiments shown in FIGS. 9(a)-9(c), the driver assembly 129 is housed within the raceway of the workstation (furniture), and the LVDS cabling 136 is run through the raceway and through to the display.

It is also to be understood that in any of the embodiments disclosed herein, the internal components and cabling (e.g. low-voltage wires, connectors, power adapters and driver assemblies) may be configured to provide power, signal delivery and connectivity to more than a single workstation. For example, in some embodiments, back-to-back workstations, separated by a full or partial wall partition (or no partition at all, as exemplified in FIG. 9(b)), may include, with a wall or other structural portion of the workstation/furniture, suitable components for providing power, signal delivery and connectivity to both workstations.

In such embodiments, a driver card may be provided per display along with a graphics processing unit. The graphics processing unit communicates to the media processor and then to the display. A standard graphics processing unit can support up to two displays while a more advanced graphics processing unit can support up to four displays. Manufacturers such as NVidia produce graphics processing units of either capability. Alternatively, multiple driver adapters may be provided for managing the delivery of media content to a plurality of displays.

FIG. 10 illustrates a viewing angle mechanism which is designed to address incident light reflection, ergonomics and user visual preferences through the inclusion of a mount 71. In the Figure, bezel 69 is shown mounted in a removable systems furniture panel 67. Bezel 69 contains a cavity for the display to recess into so that the display can be flush mounted with the furniture panel. Bezel 69 can be adjusted to exclude the custom cutout for the video conferencing camera. Bezel 69 can be constructed from plastic, aluminum or steel and fabricated in various methods but not limited to extrusion, die casting, machining, stamping or injection molding depending on the application. Bezel 69 may contain a cosmetic finish such as anodizing, painting or powder coating. Bezel 69 may include a lip that rests on the front surface of the furniture panel, creating an overlap.

The example embodiment may utilize existing LCD mounting technology, based on industry standard VESA hole patterns (70, 72) are dimensions. The typical furniture frame is 3½ inches thick providing ample space to include an LCD display on both sides of the furniture systems. As well, due to the articulating arm mount 71, there is the flexibility to adjust the display to meet personal preferences. The viewing angle mechanism may address incident light reflection, ergonomics and user visual preferences through the inclusion of an articulating arm.

FIG. 11 depicts a cross section of the display panel within the housing, indicated as cross-section ‘A’ in FIG. 10. Display bezel 69 may be form fitted to panel 67, and may be secured, for example, via a compression mounting system 73 (for example, plastic, metal or aluminum) to secure it to the furniture panel 67 during installation. In the example attachment mechanism shown, a screw 74 is provided for adjusting the mounting clip to secure it in. The articulating mounting arm is fastened to the bezel 69 via screws and the display is secured to the VESA mounting plate on the articulating arm via screws. The display has a default position that is flush to the front of the bezel. It can be moved forward, up or down by utilizing the articulating arm 76. The LVDS cable 75 may be run through the articulating arm and into the display to provide both power and video. The LVDS interface 78 receives signals from the driver assembly.

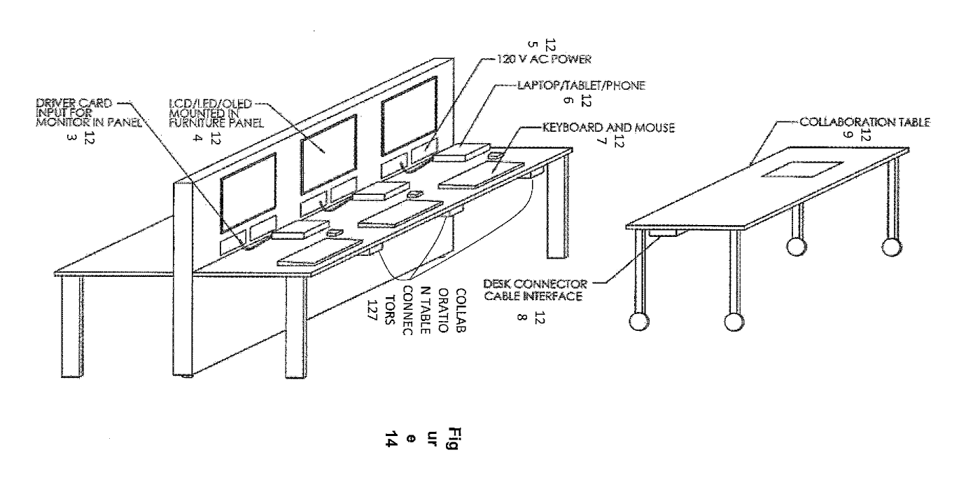

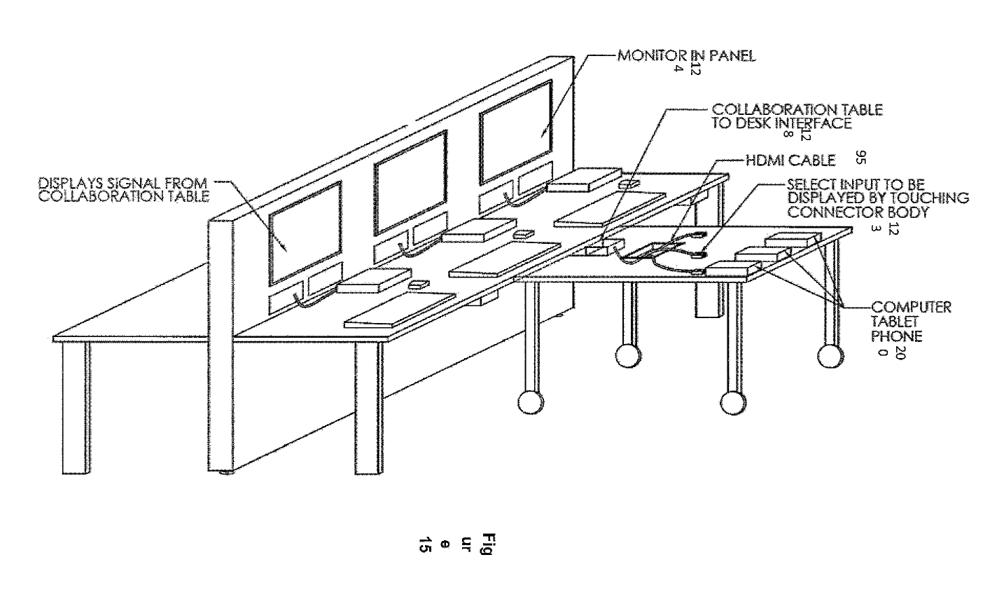

FIG. 12 illustrates an example embodiment of the attachment of the bezel, showing a rear view of the display bezel and the furniture panel. The furniture panel clips onto the furniture frame utilizing clips 87. In some configurations, no change need be made to the conventional mounting process to accommodate securing the in-panel display. The bezel/housing may be clipped into the furniture panel by screwing the clips 87 down once it has been fitted through. Working together, the mounting clips 87 and the bezel lip 69, compress the furniture panel to secure the bezel in place (see detail A in FIG. 13). LVDS cable, USB cable, and speaker wire are run from the driver assembly in the raceway through the furniture housing and directly into the LCD display, camera and microphone, and speakers, respectively. The speaker mount 83 is fixed to the bezel from the rear after the bezel has been inserted in the furniture panel. The speakers then screw into the mount to hold them in place. Rear cavity 86 of the bezel can be a single construction with the front bezel or made of separate pieces and joined with a suitable manufacturing technology depending on the material selection.

FIG. 13 illustrates an example clamping mechanism for securing the bezel/housing to the furniture panel. The clamping mechanism consists of cylindrical standoff that is integral to the bezel cavity. The standoff houses screw 89 and moveable cam 92, which is threaded on screw 89 via internal threads 91. The standoff has an open face of a minimum of 90 degrees along its length. In addition, at the top of the cylinder, an opening of 180 degrees exists. Moveable cam 92 rests in the 180 degree opening when the bezel is inserted into the cavity. To secure the bezel in place, the screw is rotated. The moveable arm will rotate and travel down the cylindrical opening (as shown at 93) until it begins to compress furniture panel 67.

Accordingly, a workstation may potentially provide access to video connectivity via connectors located in the race way; an increase in connectivity through integration with laptops, mobile, PC and tablets; improved aesthetics because of the minimalist nature of the solution (OLED/LED/LCD is embedded in the furniture panel); the ability hide various components and cabling in the raceway; a reduction in the need for additional components such as a mouse and keyboard because of the option to incorporate touch displays, camera or voice recognition to provide an interface for control of the input device (mobile, PC, tablet); a reduction in service & maintenance complexity because of modularization of the display into 3 components; greater asset utilization because of the increased connectivity (shared/hoteling workspace); improved privacy for workers in open concept floor plans.

In some embodiments of the present disclosure, furniture panels 51 are shown as being supported in a modular fashion by frame 50, as a vertical portion (or vertical extension) of a modular furniture assembly. Such an assembly may be, for example, an office partition, which may optionally form a portion of a desk, workstation, and/or cubicle. In such embodiments, the furniture panels can be formed from, but are not limited to, polyester, leather, veneer, plastics, aluminum, steel, laminate and wood. Frames 50 are typically comprised of steel, aluminum and plastic, or combinations thereof.

In some example embodiments, a media presentation workstation, optionally for use with a portable media access and control unit (described below) may include the following:
multi-input video signal connectivity—e.g. HDMI and VGA (any video or data cable) for improved connectivity. These cables may be housed within the raceway and accompanying systems furniture panel as described above;
a retractable cabling assembly built into the housing for improved aesthetics and easy accessibility;
a DVI scaler and HDMI switch enclosed within the housing to provide dual screen capability and switching capability;
a AV control system built into the housing to provide control over video and data signals and send directions to the driver card and display;
an option within the housing to dedicate one of the video inputs for video conferencing to enable full video conferencing capability;
a ‘plug and play’ cable assembly housed underneath the desk or table that enables connectivity and control commands to be shared between the workstation and a collaboration unit (described below);
one on/off button housed within each of the video and data cables provides connectivity and sends video and data signals/commands to the driver assembly/card and ultimately the OLED/LED/LCD panel to instruct what content should be displayed;

The aforementioned components may be housed and embedded (via a cutout) in systems furniture tables (e.g. mobile or immobile), which may be useful in saving valuable workstation space, the employee office footprint and associated costs. Accordingly, a modular ‘plug and play’ collaborative workstation may increase connectivity, save space, maintain privacy, and foster collaboration in a work or trade show setting. The system may provide connectivity via plug and play cable assembly housed discretely underneath the desk or table that enables connectivity and control commands to be shared between the workstation and mobile media devices, as described below.

It is to be understood that the examples provided herein, in which the system is configured as a modular workstation, represent but one example implementation of the present disclosure. In other embodiments, the system may instead be provided in other configurations in which the display and other media components are internally connected via low-voltage cables. For example, the display may be provided within other furniture such as tables (e.g. recessed within a horizontal surface of a table), chairs (e.g. in the armrest of a chair), sofas, mirrors, shower stalls, kitchen appliances, and cabinetry, where via low-voltage cables are connected, within the furniture, to a driver assembly housed within the furniture, that receives external power at a safe and accessible location of the device. The power adapter may also include a battery (e.g. a rechargeable battery) to enable mobile and electrically disconnected operation of the system. Still other applications include media display systems for furniture in various transportation systems, such as displays integrated in the back of seats within cars, airplanes, trains, and boats.

In other embodiments, the system may instead be provided in non-furniture settings, such as within a temporary wall or fixed wall, where the display and other media delivery and recording devices are supported within the wall and connected, via low-voltage cables to a driver assembly housed within the wall for signal and power delivery, where the power adapter is located at a position that is accessible (such as within a junction box) in accordance with building code regulations. Other applications include fixed and portable signage or media presentation devices.

Accordingly, such an embodiment may be employed for providing electrically-safe home theatre systems. One example of such an embodiment is a wall segment configured for displaying content, such as a portion of a trade show exhibit or other marketing and/or promotional media display. Alternatively, the system may be implemented within a mobile transportation setting, such as within a car, bus, or public transit vehicle.

The preceding embodiments may be configured to be optionally interfaced with a media collaboration device, such as any one of the following products: Steelcase—MediaScape; Haworth—Workware; Teknion—ClubTalk; Barco—Clickshare; Extron—Show Me; and Crestron—Connect,

However, as described below, the integrated media presentation furniture systems described above may additionally or alternatively be interfaced with a portable media access and control structure (e.g. unit), such as a table or cart, which includes multiple media inputs for collaborative use, and switch mechanisms for directing which media input is displayed.

FIGS. 14 and 15 illustrate an example embodiment in which a portable media access and control unit 129 is employed to provide collaborative media sharing and viewing at one of a plurality of workstations. It is to be understood that this embodiment represents but one example of a system involving a collaborative media sharing device, and that other configurations may be employed without departing from the intended scope of the present disclosure.

For example, the portable media access and control unit of the present embodiment, shown as a portable table structure, may be substituted, in other embodiments, for a collaboration cart, or other portable media collaboration and connectivity selection device. A connection system is illustrated for creating ad hoc meeting spaces equipped to transmit video signals from the portable media access and control unit to a desk display. As described further below, the connectivity system may comprise a proximity sensor, a magnetic system or locking the table to the desk, and audio, video and DC power connector(s) for sending signals between the table and the systems furniture unit.

Referring now to FIG. 14, a plurality of individual workstations (which may be mutually attached or physically separated) are shown separate from a mobile portable media access and control unit 129. As shown in the Figure, the workstations include at least one media display or presentation device, and may be integrated media workstations according to the embodiments described above. For example, a given workstation may include a media device such as a display 124, and may optionally include power source 125, a computing device 126, an input device 127, and an optionally an integrated driver assembly and power adapter for providing low-voltage media signals and power to an integrated display. In other embodiments, a writing panel may be added to one or more workstation modules to further facilitate collaboration.

FIG. 15 shows the interfacing of portable media access and control unit 129 with one of the workstations, providing an on-demand collaborative meeting environment. In the embodiment shown, portable media access and control unit 129 is mated with the connectors and interface housed on, within, or underneath the workstation. Power is sourced from the workstation and signals are sent to the display 132 via media (HDMI) connectors from the users. Users pull out the HDMI connectors, plug into either a laptop, mobile, PDA or tablet 200, and select the selection mechanism (e.g. capacitive touch device) on the connector 123 to start displaying the content on their device.

Portable media access and control unit 129 may be employed to convert a traditional desk into a small team meeting space, which may be useful in utilizing existing furniture and space to function as both a desk and a meeting environment, addressing resource scarcity issues in the workplace. The portable media access and control unit offers mobile collaboration capability, with the ability to position the mobile collaboration station next to an existing workstation, connect, and begin sharing. This may increase collaboration in the workplace because of the simplicity to connect, and share. The system allows for a number of users to connect to the display digital device that outputs a video signal, and reduces dependency on a single device for presentation purposes.

This scheme of dividing meeting room technology into functional mobile building blocks integrated into furniture provides new opportunities for resource management and optimization. This model is different than the current strategy of fixing audio video equipment in racks dedicated to a specific room. In relative terms, display technology continues to become more affordable relative to switching and control technology. Given that not all meetings require switching and control hardware, purchasing meeting room technology in a suitable ratio of displays to collaboration technology will provide organizations with the ability to more accurate align technology requirements with actual use case demand. Through its mobility, the portable media access and control unit may achieve higher utilization rates than fixed technology as it can be shared between meeting spaces, ad hoc and formal, for meeting types that meet its target use case. Analytics and scheduling technology can be bunt in to the control system to track and report usage as well as facilitate scheduling of the resource.

It is to be understood that the present embodiment, and variations thereof, may be employed in other settings, such as in healthcare and education (e.g. classroom) settings, which are resource-constrained environments in which collaborative viewing and sharing of media is prevalent and/or desirable.

Furthermore, although the portable media access and control unit 129 is shown as being capable of docking to a workstation, it is to be understood that in other embodiments, the portable media access and control unit may be interfaced (i.e. configured to dock) with another type of furniture, fixed or mobile, or a wall with a fixed display and a suitable mating/docking interface.

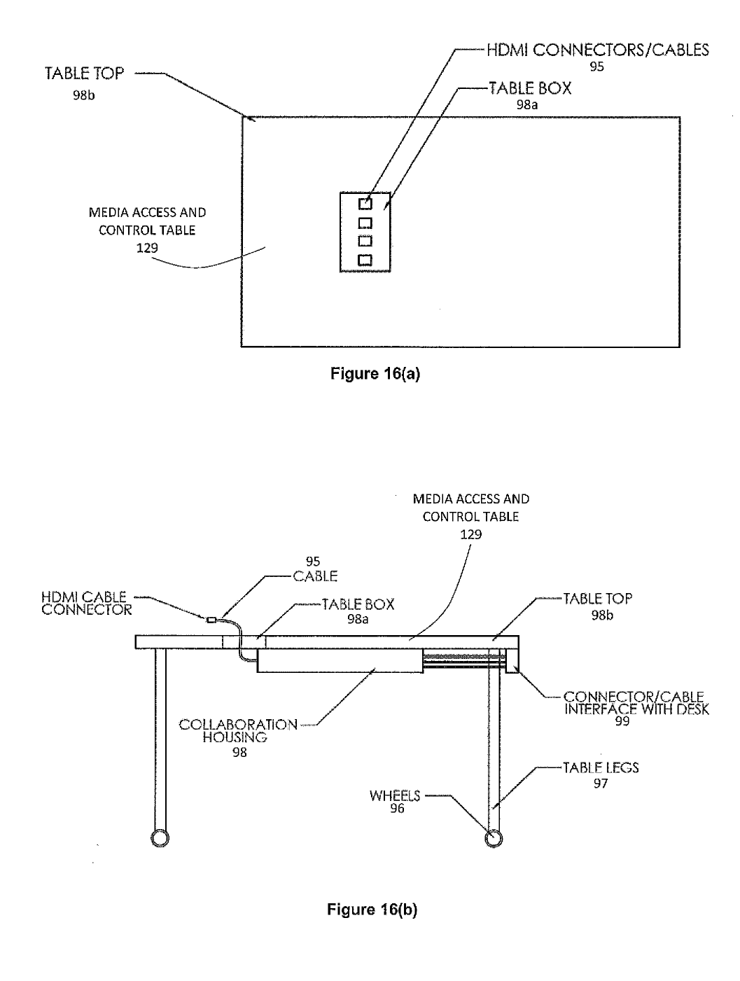

FIGS. 16(a) and 16(b) depict top and side views, respectively, of an example portable media access and control unit 129 that may be interfaced with a workstation system, where the workstation system may be similar to the embodiments described above. Example portable media access and control unit 129 may be provided in a mobile (for example, via wheels 96) or fixed conference table of varying dimensions and materials (e.g. laminate, composite, wood, metal, and/or plastic).

According to one example embodiment, a housing (e.g. a table box 98a) is included (e.g. provided on or within the table top 98b) that contains a media selection and switching assembly that provides access to media input (e.g. HDMI) cables 95 from the collaboration system. Housing 98, which contains components for establishing switchable connectivity (as further described below), is affixed (e.g. via fasteners, adhesives, or otherwise affixed) to the bottom side of the table top.

Portable media access and control unit 129 may be placed on wheels 96 or another suitable transport mechanism to enable a mobile meeting space. Power is provided when the portable media access and control unit is docked (as described below) to a desk/workstation and a connection is made to mating device. Alternatively, power may be provided by a mobile power source, such as a rechargeable battery.

Connector/cable interface 99, described in further detail below, may include a digital video connector (e.g. HDMI) and an additional connector, which transmits control and DC power (e.g. a 3 pin connector, such as a TRS connector) from a workstation.

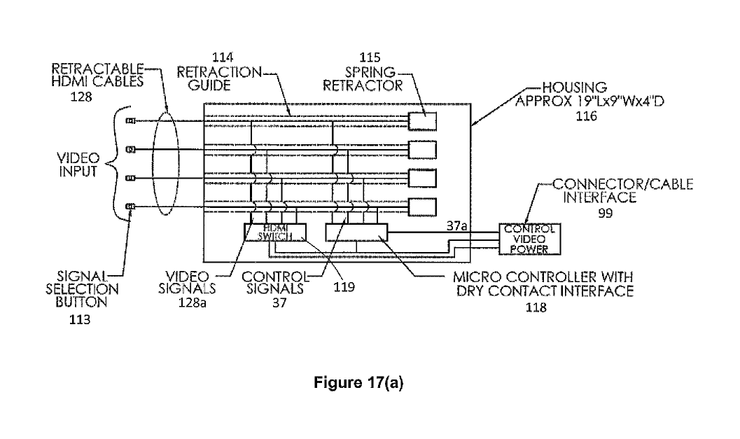

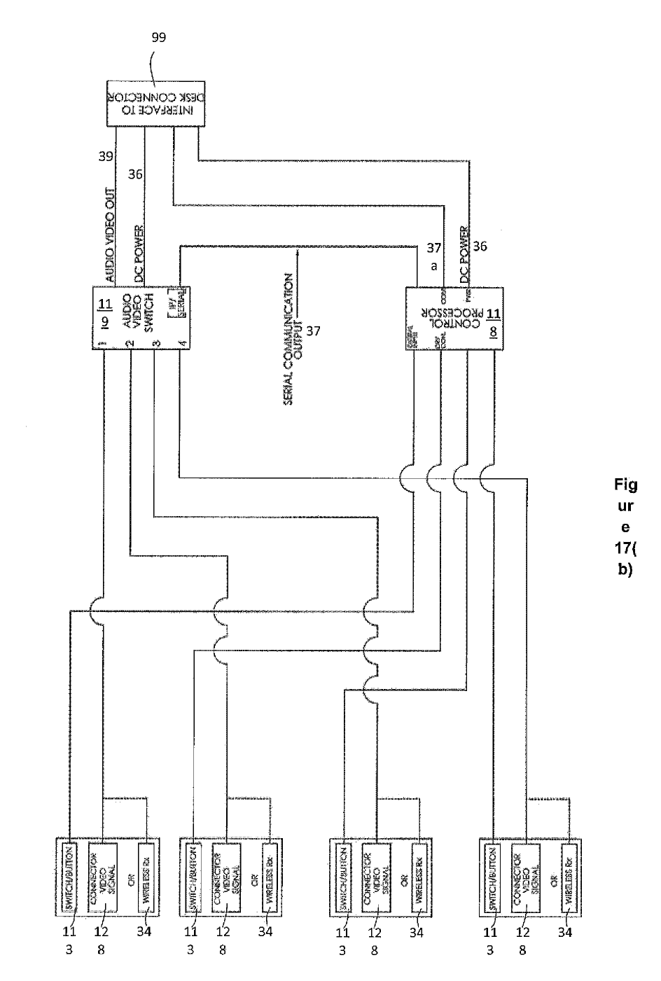

FIGS. 17(a) and (b) provides a block diagram summarizing the components of an example embodiment of the media selection and switching assembly housed or supported by portable media access and control unit 129. This block diagram outlines the components of the example assembly, along with the signals that are distributed from the various components (video, switching, processing and power signals). The example drawing depicts a quad input, single output video digital video collaboration assembly designed to mount under a mobile or fixed table to enable dynamic meeting environments. It will be understood that other configurations may be possible, including single input to multiple output, multiple input to single output, and multiple input to multiple output.

As shown in FIGS. 17(a) and 17(b), which illustrate an example embodiment of the components of the media selection and switching assembly, a user may connect their computing device (laptop, PC, tablet, mobile phone) to the portable media access and control unit in order to optionally connect with a collaborative display and/or other media device. Shown in the Figure are components that may be housed below the table (e.g. in portable media access and control unit/housing 98) and out of sight to the user, and components that are in sight (e.g. one or more user-activated signal selection devices and video connectors 113) for the user.

For example, in the example embodiment shown, one or more media cables and control cables (e.g. 4 HDMI/video cables 128 and associated control cables) are provided in the meeting table box (e.g. housing 116). The media cables 128 may be enclosed in a cable retraction mechanism for convenient storage when the table is not in use. The retraction mechanism (e.g. via cable retraction guide 114 and spring retractor 115), described further below) may be provided to minimize or reduce the potential for tangling cables through its straight retraction path. In an alternative embodiment, the media box may contain connectors, and connections may be made via external, user-provided cables. In other embodiments, connectivity may be provided via multi-input video signal cabling for portable and non-portable video and data devices (examples: Android, iPod, iPad, iPhone, PC, tablet, BlackBerry devices).

To share a device that is connected to one of the media cables, a user presses on the body of the signal selection device 113 (e.g. a button or a capacitive touch switch or mechanical switch). The switch closes a connection creating a voltage across an opto-isolator input on microcontroller 118. Microcontroller 118 then communicates a control command 37, based on a software program, which is sent to the digital video switch 119, for example, via a serial connection. The command 37, which is received by digital video switch 118, is processed by HDMI switch 118 in order to determine the routing of a media signal from one of the multiple HDMI inputs to HDMI output. The routed video signal is transmitted from HDMI output to interface 99, which interfaces (either through direct or wireless connectivity) to a media input of a display device or workstation. A control signal 37a may also connect with interface 99, for example, in order to provide control commands to, or receive control commands from, a display or other media device. Transmitting video from the user device can be accomplished through the digital video cable as described, or through alternative means, such as, but not limited to, via USB through a converter to digital video such as HDMI, and via wireless protocols such as an Apple Airplay or Intel WiDi to a receiver that decodes and outputs a digital video signal such as HDMI.

As described further below, in some embodiments, interface 99 may be configured to mate with corresponding connectors of an integrated media workstation, such as a workstation according to the embodiments disclosed above. The mating may be a direct, connector-to-connector mating, or may be facilitated through appropriate cables. The interface 99 may include one or more power connectors, such that a remote power source can provide power to the components of the portable media access and control unit 129 when a connection to media-integrated workstation is made. Such an embodiment is shown in FIG. 17(b), where interface 99 is shown in detail as including a HDMI output 39, DC power 39, and control signal connectivity 37a. It is also to be understood that the interface may be a wireless interface, such as a Wi-Fi node, or a wireless transponder employing protocols such as NFC, Zigbee, infrared signals, and the like (as shown at 34 in FIG. 17(b)).

Accordingly, the portable media access and control unit 129, delivering media to a media presentation device of the workstation and optionally receiving power from the workstation, provides a collaborative and controllable media delivery and display system. The mobile portable media access and control unit 129 and workstation, operating together, provide a simplified AV control system for multiple users, enabling them to meet, share and distribute video and audio content from their individual devices (laptop, tablet, PC, mobile) to the group via the connected display device.

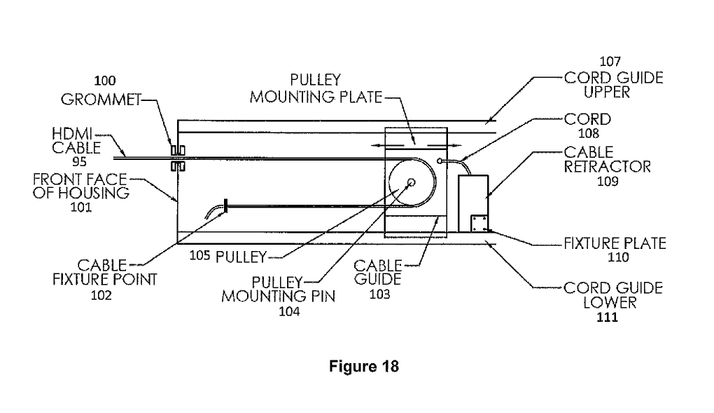

FIG. 18 shows an example cord retraction mechanism for media cables (HDMI 95, VGA, data or other) that may be housed in the collaboration system enclosure. Video or other media cable connectors 95 (e.g. HDMI, VGA) are located externally on the enclosure with the respective cables entering the enclosure through an orifice (e.g. grommet 160). The cables engage a pulley 105 housed within the enclosure and are secured to the switch. Cables are pulled by the user and the cables extend from the front of the housing 101 along the cord guide 107, triggering, for example, a ½ lb or ¾ lb resistance applied to the mounting plate via the cord 108 which is spooled in the cable retractor 109. The cable retractor is fixed to the enclosure with fixture plate 110. The pulley mechanism is secured in the card guide 107 & 111 with a pulley mounting plate 106. The pulley mechanism extends to manage the tension until the proper distance is locked in. The furthest extension of the pulley mechanism is achieved when the pulley mounting plate 106 reaches the edge of the card guide 107 & 111 at the front face of the housing 101. The pulley has a number of settings/ridges to establish a locking mechanism and prevent retraction without user intervention. To retract, the user tugs at the cable slightly, the pulley unlocks and the cable 108 retracts back into the mechanism 109 pulling the mounting plate back to the rear of the enclosure.

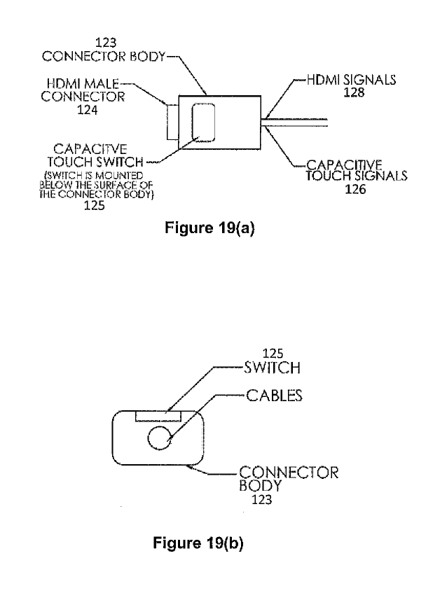

FIGS. 19(a) and (b) show an example the user-side media connector with an integrated switch, showing (a) top and (b) side views. This connector may be plugged into a suitable computing device, such as a laptop, PDA, mobile or tablet device. The connector 123 shown in the Figure sends the control signal 126 (on/off touch) to the control microprocessor, to control the display for displaying or playing back his or her content via HDMI signal 128. In the embodiment shown, when the user hits the capacitive touch mechanism 125, the switch lights up to indicate that it is on. When the user hits it again, the light goes off to indicate that it is off. It is to be understood that the switch may take on a wide variety of alternative forms, including pushbutton or toggle switches, foot pedal, and software-based switches residing within the user's computing devices.

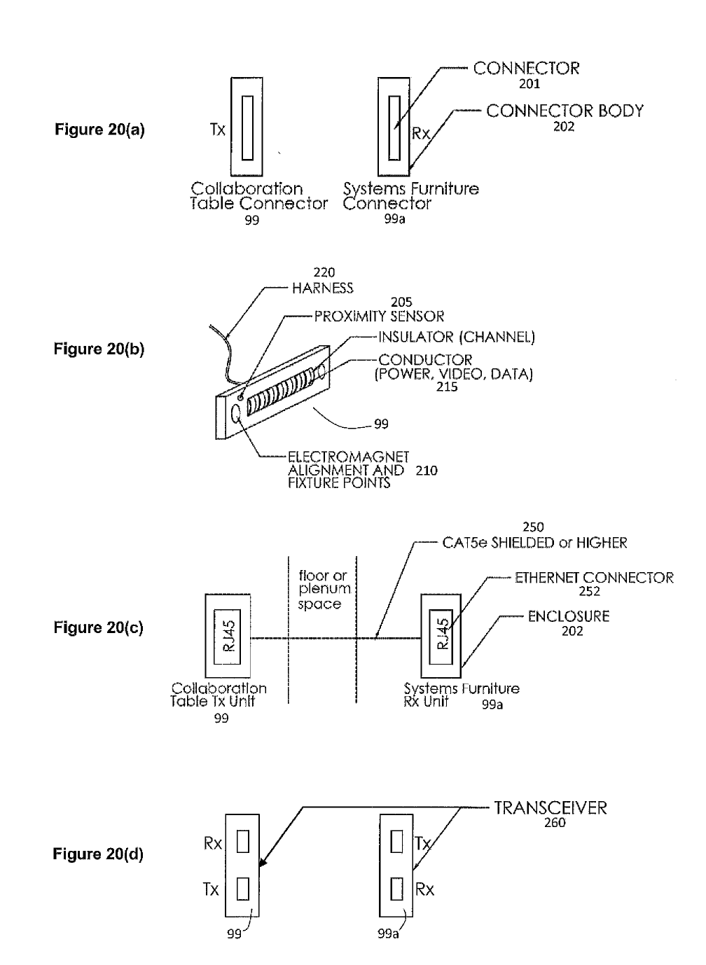

It will be understood that many different configurations may be employed to dock the portable media access and control unit 129 to a workstation or other structure. FIG. 20(a) provides a simplified block diagram of the connection interfaces 99 and 99a that may be provided at the edge of the portable media access and control unit and the systems furniture working surface will form a mating connection for the transmission of audio, video, low voltage power and control signals. The interfaces are shown having a connector 201 and a connector body 202, although a wide variety of interface types are possible, including those that involve direct contact and wireless or optical transmission. The connection device for the portable media access and control unit is listed as Tx, because audio and video signals will be transmitted to the driver card in the systems furniture. The systems furniture unit connector is labelled Rx because it will receive audio and video signals from the collaboration table connector. It is to be understood that bidirectional transmission may be employed in alternative embodiments.

In some embodiments, the access and control table 129 may physically mate to the systems furniture unit, while in other embodiments, the portable media access and control unit may dock at a distance from to the systems furniture unit (e.g. in one embodiment, up to 328 ft. from the display and connector) by utilizing an example connection interface outlined below. In addition, IrDA or RS-232 146 control functionality may be built into the portable media access and control unit for communication to the remote display (e.g. for ON/OFF control) and future applications. These optional modifications provide greater overall flexibility for end users.

Referring now to FIG. 20(b), in one example implementation, the docking or connector interface 99 may contain three subsystems; an identification device, such as a proximity sensor 205 or RFID tag, a locking mechanism, for example employing electromagnets 210 that are activated based on proximity, and a connector interface 215 for transmitting DC power and media signals (e.g. audio, video and control signals). In some embodiments, the connector for the power, audio, video and control may be positioned to be flush with the surface of the table edge, or mounted on the side face of the table top. The conductors (contacts) of the connector may be configured to provide some spring force. In one embodiment, when the magnetic lock engages between the portable media access and control unit and the desk systems furniture, the conductors compress sufficiently to ensure sufficient electrical contact. The connector interface 99 may be secured to the media access and control unit via a harness 220 or other suitable support mechanism.

FIG. 20(c) illustrates an embodiment in which docking is performed remotely via a cable 250 connecting a mobile media access and control unit with a systems furniture unit. For example, the assembly may contain a cable retraction mechanism (as in FIG. 16), a switch or switches in the connector head, a micro controller, and a digital video switch, as shown above. An HDMI over UTP (unshielded twist pair) or STP (shielded twisted pair) transmitter may be employed to receive the output of the switch. This type of device is commercial available and based on a standard chip set technology like HDbaseT. It transmits uncompressed full HD digital video, audio, 100BaseT Ethernet, power over cable and various control signals through a single 100 m/328 ft CAT5e/6 cable 250 with RJ45 connectors 252. An HDMI over UTP/STP receiver could be located on the display side, and the output video signal would be transmitted over HDMI to the driver card input. Any additional control signals could be broken out routed to the appropriate control inputs on the driver card. Alternatively, a compatible switch can be placed in between the systems furniture connector and mobile media access and control unit. For example, Crestron DM switching equipment may be employed.

FIG. 20(d) illustrates an embodiment of a connector interface including wireless transceivers 260 for wireless transmission of audio, video and control. In this embodiment, the portable media access and control unit and the systems furniture unit may be powered independently. For example, the portable media access and control unit may include a battery (e.g. a rechargeable battery, such as a removable rechargeable battery pack) that enables power to be provided in a mobile/portable configuration. The power requirements for the portable media access and control unit may be low, as the only functionality required is switching and optional processing of incoming media signals, as opposed to the systems furniture unit which provides additional power for the media devices.

The transceiver consists of transmitter and a receiver for high bandwidth duplex communication. Technologies such as a multi-gigabit transceiver (MGT—produced by companies like Xilinx)

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Therefore what is claimed is:

1. An integrated media presentation furniture system comprising:
a furniture structure configured to support at least one low-voltage media device thereon or therein;
an electrical conduit supported within said furniture structure;
a driver assembly housed within said electrical conduit, wherein said driver assembly comprises:
an input interface configured to:
receive a source of low-voltage power; and
receive one or more media signals from an external device; and
a media processor for processing said media signals to produce low-voltage output signals formatted for said low-voltage media device; and
an output interface configured to:
output said low-voltage output signals; and
output low-voltage power suitable to power said low-voltage media device; and
connection means for connecting said low-voltage media device to said output interface of said driver assembly.

2. The integrated media presentation furniture system according to claim 1 wherein said input interface of said driver assembly comprises one or more media input connectors, wherein said furniture structure is configured such that said media input connectors are externally accessible and connectable to said external device for receiving media signals.

3. The integrated media presentation furniture system according to claim 1 wherein said input interface comprises a wireless receiver for receiving media signals from said external device.

4. The integrated media presentation furniture system according to claim 1 wherein said furniture structure is a wall panel system.

5. The integrated media presentation furniture system according to claim 4 wherein said wall panel system is a modular wall panel system comprising one or more removable panels.

6. The integrated media presentation furniture system according to claim 5 wherein one of said removable panels is configured to support said low-voltage media device.

7. The integrated media presentation furniture system according to claim 1 wherein said low-voltage media device is a low-voltage display device.

8. The integrated media presentation furniture system according to claim 7 wherein said output interface comprises a low-voltage device selected from the group consisting of LVDS, FPD-link, and FlatLink.

9. The integrated media presentation furniture system according to claim 7 wherein said driver assembly is further configured to provide one or more of gamma correction, backlight control, pixel mapping, graphics processing, brightness control, and touch input processing.

10. The integrated media presentation furniture system according to claim 7 further configured to support one or more additional low-voltage media devices, wherein said driver assembly is configured to provide suitable low voltage signals and low voltage power to said one or more additional low-voltage media devices.

11. The integrated media presentation furniture system according to claim 10 wherein said one or more additional low-voltage media devices are selected from the group consisting of speakers, a microphone, and a camera.

12. The integrated media presentation furniture system according to claim 1 wherein said source of low voltage power is a power adapter housed within said electrical conduit.

13. The integrated media presentation furniture system according to claim 12 wherein said power adapter is configured to receive AC line power and output low-voltage DC power.

14. The integrated media presentation furniture system according to claim 13 wherein said power adapter is connectable to an external line power source via an armored cable housed within said furniture structure.

15. The integrated media presentation furniture system according to claim 1 wherein said electrical conduit comprises a power outlet.

16. The integrated media presentation furniture system according to claim 15 wherein said driver assembly is configured to receive low-voltage power from an external power adapter that is connectable to said power outlet.

17. The integrated media presentation furniture system according to claim 1 wherein said driver assembly is configured to receive low-voltage power from a battery.

18. The integrated media presentation furniture system according to claim 1 wherein said furniture structure comprises a plurality of low-voltage media devices, and wherein at least two of said low-voltage media devices have separate driver adapters associated therewith.

19. The integrated media presentation furniture system according to claim 1 wherein said furniture structure is selected from the group consisting of a wall panel, table, chair, sofa mirror, cabinet, shower stall.

20. The integrated media presentation furniture system according to claim 1, further comprising:
an external connection interface in electrical communication with said driver assembly;
wherein said external connection interface is configured to interface with a portable media device such that media signals are received from the portable media device and provided to said driver assembly for processing therein; and
wherein said external connection interface is further configured to provide low-voltage power from said driver assembly to the portable media device.

21. A portable media access and control unit, comprising:
a portable support structure;
a media selection and switching assembly supported by said portable support structure, said media selection and switching assembly comprising:
a plurality of media connection devices, each media connection device comprising:
an external input interface for receiving media signals from an external media device; and
a media selection device associated with said external input interface, wherein said media selection device is configured to be actuated by a user;
a media switching device having a plurality of inputs, wherein each input is in electrical communication with one of said external input interfaces; and
a controller in electrical communication with said media selection devices and said media switching device;
wherein said controller is configured to control said media switching device such that when a user activates a media selection device of a particular media connection device, the media signal provided to the external input interface of the particular media connection device is provided at the output of the media switching device; and
an external connection interface configured to interface with a corresponding external connection interface of an integrated media presentation furniture system according to claim 20.

22. The portable media access and control unit according to claim 21 wherein each of said external media connection interfaces comprises a media cable configured to connect to an external media device.

23. The portable media access and control unit according to claim 22 comprising cord retraction mechanisms to control the extension of said media cables.

24. The portable media access and control unit according to claim 21 wherein said external connection interface is a wired interface.

25. The portable media access and control unit according to claim 21 wherein said external connection interface comprises a wireless interface.

26. The portable media access and control unit according to claim 21 wherein said external connection interface comprises a locking mechanism configured to lock the portable media access and control unit to the integrated media presentation furniture system.

27. The portable media access and control unit according to claim 21 further comprising an identification device configured for communicating an identity of the portable media access and control unit to the integrated media presentation furniture system.

28. The portable media access and control unit according to claim 21 further comprising a proximity sensor for detecting the proximity between the portable media access and control unit and the integrated media presentation furniture system.

29. An integrated media presentation furniture system comprising:
a furniture structure configured to support at least one low-voltage media device thereon or therein;
an electrical conduit supported within said furniture structure;
a low-voltage power distribution assembly housed within said electrical conduit, wherein said low-voltage power distribution assembly comprises:
an input interface configured to:
receive a source of low-voltage power; and
receive at least one low-voltage media signal from an external device; and
an output interface configured to:
output said low-voltage media signal; and
output low-voltage power suitable to power said low-voltage media device; and
connection means for connecting said low-voltage media device to said output interface of said low-voltage power distribution assembly.
